(19) United States
(12) Patent Application Publication
(10) Pub. No.: US 2005/0021578 A1
(43) Pub. Date: Jan. 27, 2005

(54) Reconfigurable apparatus with a high usage rate in hardware

(75) Inventors: Li-Hsun Chen, Tainan Hsien (TW); Oscal T. -C. Chen, Yunghe City (TW); Teng Yi Wang, Tainan County (TW); Ruey-Liang Ma, Ilan County (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 10/730,114

(22) Filed: Dec. 9, 2003

(30) Foreign Application Priority Data
Jul. 24, 2003 (TW) 092120215

(51) Int. Cl. G06F 7/38

(52) U.S. Cl. 708/230

(57) ABSTRACT

A reconfigurable apparatus with a high usage rate in hardware is disclosed, which comprises at least one reconfigurable unit that has a plurality of processing units and at least one switch box connected to the processing units. The reconfigurable unit receives at least one reconfiguration signal to dynamically configure the processing units and the switch boxes as a new functional unit.

### BACKGROUND OF THE INVENTION

1. Field of the Invention

The present invention relates to a reconfigurable apparatus with a high usage rate in hardware, which possesses advantages of both fine-grain and coarse-grain architectures and can be applied in a reconfigurable processor or system.

2. Description of Related Art

The architecture for computing a specific algorithm typically makes use of the programmable processor or the application specific integrated circuit (ASIC). The programmable processor implements algorithms via instruction execution and performs computation via various instructions, so as to have the maximum computing flexibility. However, the performance is limited by hardware factors such as the instruction set designed for the processor, the number of registers and buses, data addressing modes, and the like. The ASIC is a hardware design for a specific algorithm and thus has high computation efficiency. However, ASIC is limited by fixed interconnection and circuit implementation at low computing flexibility.

Hence, the reconfigurable processor is applied to improve the aforementioned programmable processor and ASIC. The reconfigurable processor has a reconfigurable mechanism to dynamically change corresponding hardware implementation according to the computation to be executed, thereby enhancing computation efficiency. Due to the reconfigurable feature, the reconfigurable processor can eliminate the limit of computing flexibility in ASIC.

Upon hardware implementation of elements for a reconfigurable unit, the reconfigurable processor can be realized by a fine-grain architecture or a coarse-grain architecture, which is described hereinafter.

The fine-grain architecture can manipulate 1-bit or 2-bit logic operations and associated interconnection operations. Further, the circuits for the cited 1-bit or 2-bit logic operations can constitute a computing unit such as FPGA, with different functional operations. However, data computed by a DSP generally have a word length of 8, 16 or 32 bits, wherein each bit has the fixed-configuration logic gates. Namely, the data computation is based on multiple bits, instead of one bit. If the architecture is configured one bit by one bit, the configuration signals, control circuits and interconnection complexity of the fine-grain architecture increase, thus increasing hardware complexity.

The coarse-grain architecture is designed to enhance computing efficiency, which is characterized in using multiple data processing components as a processing unit and applying data-parallelism such as SIMD, MIMD or VLIW to increase computing efficiency. The processing unit can include computing units, registers or data memory. The computing units can execute basic instructions for arithmetic, logic, multiplication, and shift operations. However, the coarse-grain architecture can use only one or a part of hardware components included in the PE for executing one specific computation at each operation. For example, when a processing unit uses an Arithmetic Logic Unit (ALU) to perform a certain computation, its hardware components such as a multiplier and a shifter for executing the other computation are idle, resulting in that the hardware components of the processing unit cannot be fully utilized and thus the computing efficiency is low. Therefore, it is desirable to provide an improved reconfigurable apparatus to mitigate and/or obviate the aforementioned problems.

### SUMMARY OF THE INVENTION

The object of the present invention is to provide a reconfigurable apparatus with a high usage rate in hardware, which can effectively compute different functions, thereby increasing computing flexibility.

To achieve the object, the invention provides a reconfigurable apparatus with a high usage rate in hardware, which includes at least one reconfigurable unit that has a plurality of processing units and at least one switch box connected to the processing units. The reconfigurable unit receives at least one reconfiguration signal to dynamically configure the processing units and the switch boxes as a function unit. The switch box includes at least one interconnection to send data of processing units.

When there are plural reconfigurable units in the inventive apparatus, the plural reconfigurable units can be homogeneous, heterogeneous or combined above.

In an embodiment of the inventive reconfigurable unit, a processing unit is a processing element (PE) capable of executing 4-bit (or more) data in independence or dependence. All PEs can have totally different, at least one different or the same computing element. For a PE design, functional units that have high similarity in their hardware components are firstly designed or selected. Circuit blocks from functional units having the same hardware components are regarded as configuring basic units of the PEs for subsequently combining with reconfigurable circuits, thereby completing PE design. Accordingly, different functional units can be configured by these PEs. Due to the high similarity in hardware, reconfigurable circuits of the PEs can further be simplified to reduce entire hardware complexity in the reconfigurable unit.

In another embodiment of the inventive reconfigurable unit, a processing unit is a basic functional unit. The basic functional unit can be an ALU, a multiplier, or a multiplication and accumulation unit. At least one basic functional unit is configured as a functional unit, thereby speeding up the computation. In addition, the partial or entire internal circuitry of at least one basic functional unit can be integrated as a functional unit. As such, implementation of basic functional units in the reconfigurable unit is changed according to the features of the algorithm computed by the inventive device, so as to increase the algorithm's performance. This can prevent the hardware in the computing unit from being idle and further increase hardware efficiency.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of functional blocks of a reconfigurable apparatus in accordance with the invention;

FIG. 2a is a schematic diagram of a reconfigurable example of the first embodiment in accordance with the invention;

FIG. 2b is a schematic diagram of another reconfigurable example of the first embodiment in accordance with the invention;

FIG. 3 is a schematic diagram of a first embodiment of the reconfigurable unit of FIG. 1 in accordance with the invention;

FIG. 4 is a schematic diagram of a 32-bit carry select adder implementation of FIG. 3 in accordance with the invention;

FIG. 5 is a schematic diagram of an 8×8-bit array multiplier implementation of FIG. 3 in accordance with the invention;

FIG. 6a is a schematic diagram of a reconfigurable example of the second embodiment in accordance with the invention

FIG. 6b is a schematic diagram of another reconfigurable example of the second embodiment in accordance with the invention;

FIG. 7 is a schematic diagram of the second embodiment in accordance with the invention;

FIG. 8 is a schematic diagram of data processing flows of a configuration operation of the second embodiment in accordance with the invention; and

FIG. 9 is a schematic diagram of data processing flows of another configuration operation of the second embodiment in accordance with the invention.

### DETAILED DESCRIPTION OF THE PREFERRED EMBODIMENT

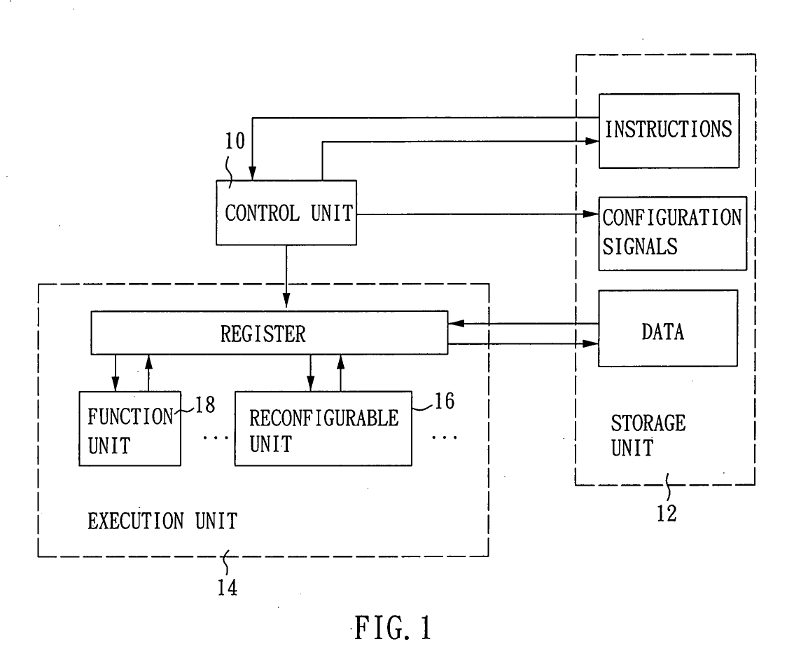

With reference to FIG. 1, there is shown functional blocks of a reconfigurable apparatus with a high usage rate in hardware in accordance with the invention. In FIG. 1, the reconfigurable apparatus includes a control unit 10 to fetch an instruction for decoding, a storage unit 12 to store instructions to be fetched by the control unit 10, configuration signals and input data, and an execution unit 14 having at least one reconfigurable unit 16 or some non-reconfigurable functional units 18 based on the requirement of the user.

Two embodiments of the inventive reconfigurable unit are further described below in their design manners and hardware architectures.

[Embodiment 1]

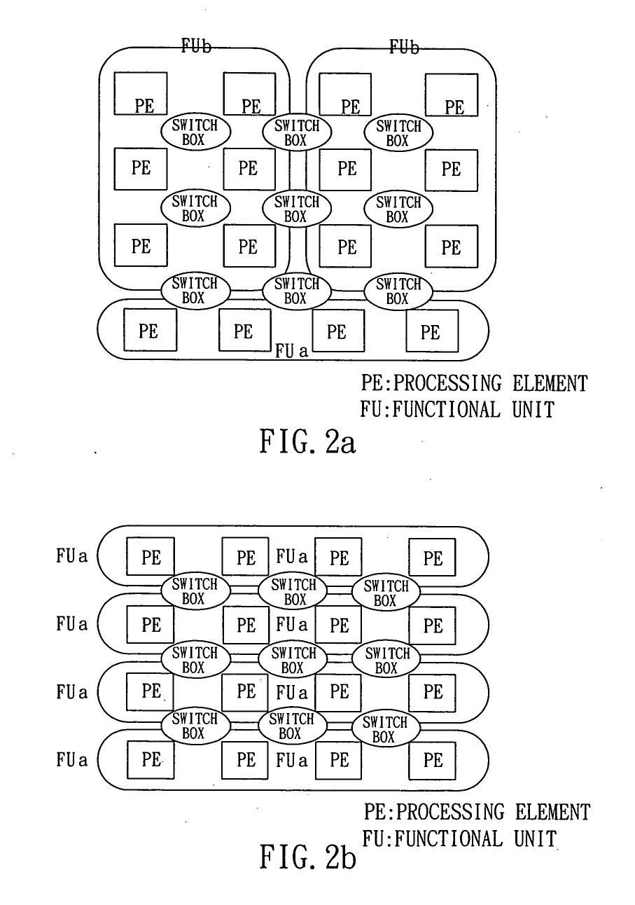

This embodiment uses a processing element capable of executing 4-bit (or more) data operation as a processing unit. With reference to FIGS. 2a and 2b, a reconfigurable unit includes a plurality of one-, two- or multi-dimensional processing elements (PEs) and switch boxes. Each PE can execute 4-bit (or more) arithmetic or logic operation. The switch boxes can transfer data among the PEs. The switch box has an interconnection circuitry (not shown) formed by at least one multiplexer or data bus, so as to link the PEs to become at least one functional unit.

Design Manner

To increase hardware efficiency for the reconfigurable unit, following design manner is applied. Firstly, functional units that have the highest similarity in hardware are selected or designed for an algorithm required by application. Next, circuit blocks from the functional units having the same hardware components are used as configuring basic units of the PEs in the reconfigurable unit. An example of a 4×4 PE array is shown in FIGS. 2a and 2b, which are two different configuration modes. In this example, four and six PEs can be combined as a functional unit a (FUa) and a functional unit b (FUb), respectively. Therefore, in addition to disposing the circuit blocks of each PE for executing the partial operations of FUa and FUb, the PE needs more switching circuits (not shown) for the capability of changing it's operations. Moreover, with the complexity of the switching circuit depending on the hardware similarity between FUa and FUb, when the hardware similarity between FUa and FUb is higher, the complexity of the switching circuit is lower, so as to reduce the hardware cost of the reconfigurable unit. Some PEs are combined to form a functional unit, however, each PE can be also operated independently.

Hardware Architecture

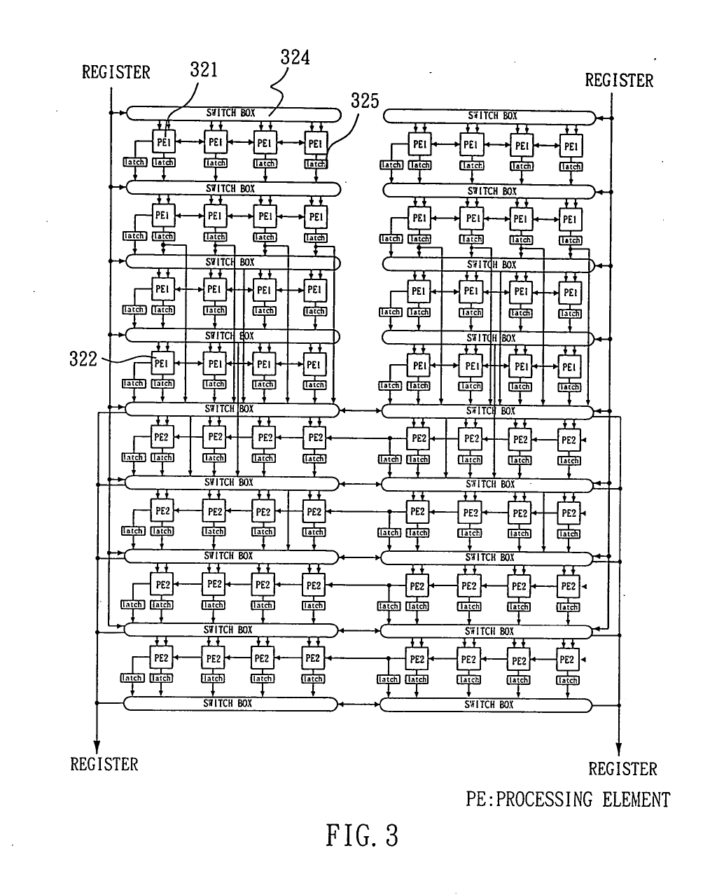

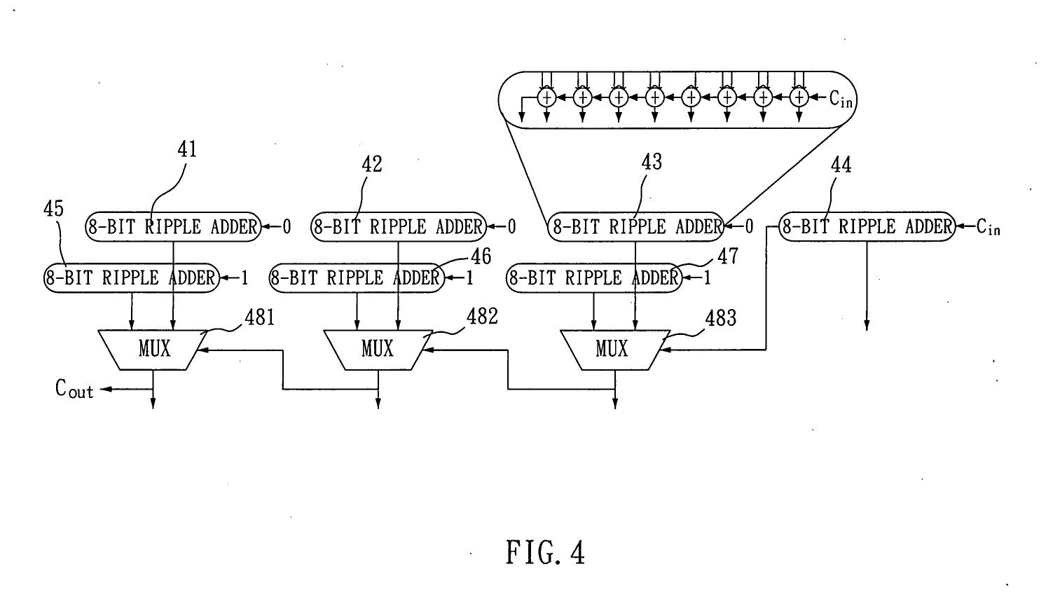

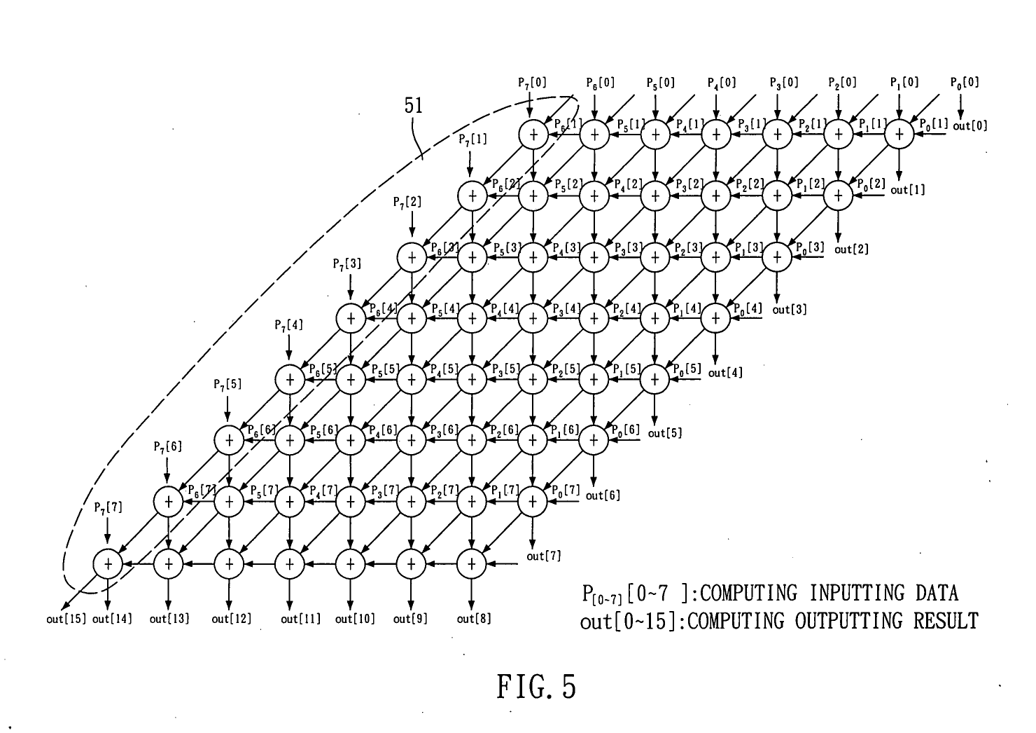

Regarding to the hardware architecture of this embodiment, FIG. 3 shows an 8×8 PE array. In FIG. 3, the array includes a plurality of PEs 321, 322, a plurality of switch boxes 324 and a plurality of latches 325. As shown in FIG. 3, PEs in each row (such as first-row PEs (PE1) 321) have the same architecture and data are transmitted downwardly. Each row of Pts 321 is a pipeline stage to speed up computation performance and increase hardware efficiency. In a general computation, multiplication and addition are the operations used frequently. Therefore, the addition and multiplication operations are the two main configuration modes in this embodiment. FIG. 4 shows a 32-bit carry select adder used in this embodiment. As shown in FIG. 4, the 32-bit carry select adder includes a plurality of 8-bit ripple adders 41, 42, 43, 44, 45, 46, 47 and a plurality of multiplexers 481, 482, 483. FIG. 5 shows an 8×8-bit array multiplier used in this embodiment. As shown in FIG. 5, the 8×8-bit array multiplier consists of a plurality of 8-bit ripple adders 51, where P_{[0˜7]}[0˜7] represents the partial products of an 8×8-bit multiplication and out[0˜15] represents the outputting result. From FIGS. 4 and 5, it is known that, due to seven 8-bit ripple adders used, a 32-bit carry select adder and an 8×8-bit array multiplier have the highest similarity in hardware.

As aforementioned, PEs of the reconfigurable unit are based on the two 8-bit ripple adders to perform the following configuration operations:
(1) combining four PEs in a same row, to form a functional unit capable of executing an 8×8-bit multiplication; (2) combining four, three or two PEs in a same row, to form a functional unit capable of executing 32-bit, 24-bit, or 16-bit carry select addition; (3) using a single PE as a functional unit capable of executing an 8-bit addition; (4) combining four 8×8-bit multipliers, two 24-bit carry select adders and one 32-bit carry select adder, to form a functional unit capable of executing a 16×16-bit multiplication. One functional unit with 16×16-bit multiplication can be divided into four sets of 8×8-bit multiplications executed by the cited four 8×8-bit multipliers. The two 24-bit carry select adders and the 32-bit carry select adder can accumulate the values generated by the cited four 8×8-bit multipliers. Further, because the four sets of 8×8-bit multiplications are essentially executed by previous four rows of PEs 321 (PE1 of FIG. 3), following four rows of PEs 322 (PE2 of FIG. 3) can be designed for only executing the addition operations, thus reducing the hardware cost.

Switch box design is also based on the above configuration operation, and thus data can be delivered among PEs for constituting at least one functional unit using at least one PE.

The reconfigurable unit can combine the PEs in order to form 8-bit, 16-bit, 24-bit and 32-bit carry select adders and an 8×8-bit array multiplier. In addition, four 8×8-bit array multipliers and three carry select adders are combined to form a 16×16-bit multiplier. Because the highest hardware similarity exists between a 32-bit carry select adder and an 8×8-bit array multiplier, PEs can be designed to change their operations, which are capable of concurrently executing a partial of 32-bit addition and a 8×8-bit multiplication, with fewer switch circuits.

[Embodiment 2]

This embodiment uses a basic functional unit as a processing unit. The basic functional unit can be an ALU, a multiplier, a multiplication and accumulation unit, registers or memory. The cited switch can transfer data among the basic functional units. The switch has interconnection circuitry formed by at least one multiplexer or data bus, to form at least one functional unit using at least one basic functional unit, thereby increasing computation speed. Alternately, the switch can connect partial internal hardware circuitry of one basic functional unit to partial or entire internal circuitry of at least one different basic functional unit, thus forming a different functional unit.

Design Manner

Design manner essentially studies features of internal hardware circuits existing in basic functional units of a processor and designs interconnections of internal hardware circuits of basic functional units, to form a reconfigurable unit. Such a design manner can perform the configuration operations to separate or combine the basic functional units according to the features of the algorithm executed presently. Thus, computing efficiency is increased.

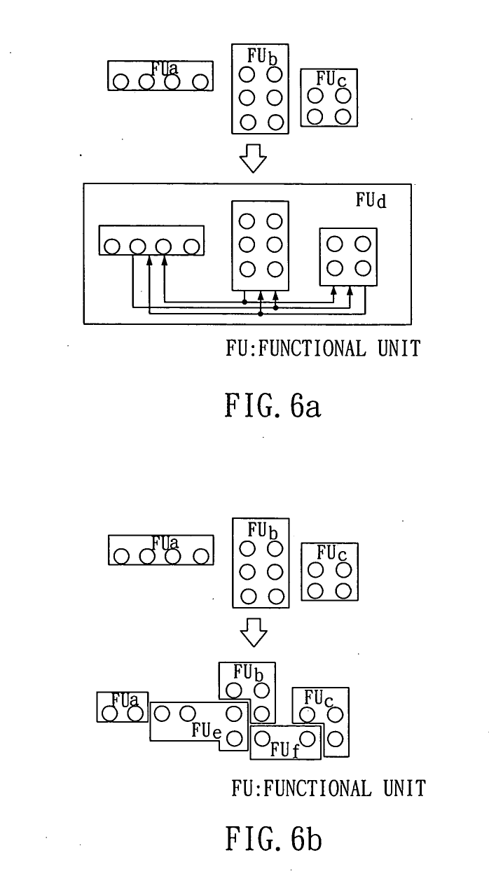

The cited configuration can combine idle circuits of a basic functional unit and circuits of other basic functional units, which forms a functional unit to perform computing and thus increases hardware efficiency. As shown in FIGS. 6a and 6b, a functional unit d (FUd) consists of three basic functional units a (FUa), b (FUb) and c (FUc) implemented in a reconfigurable unit. As shown in FIG. 6a, internal hardware circuits in different basic functional units can be redistributed to separate the three basic functional units and form five functional units shown in FIG. 6b. In FIGS. 6a and 6b, circles represent internal hardware circuits of a basic functional unit.

Hardware Architecture

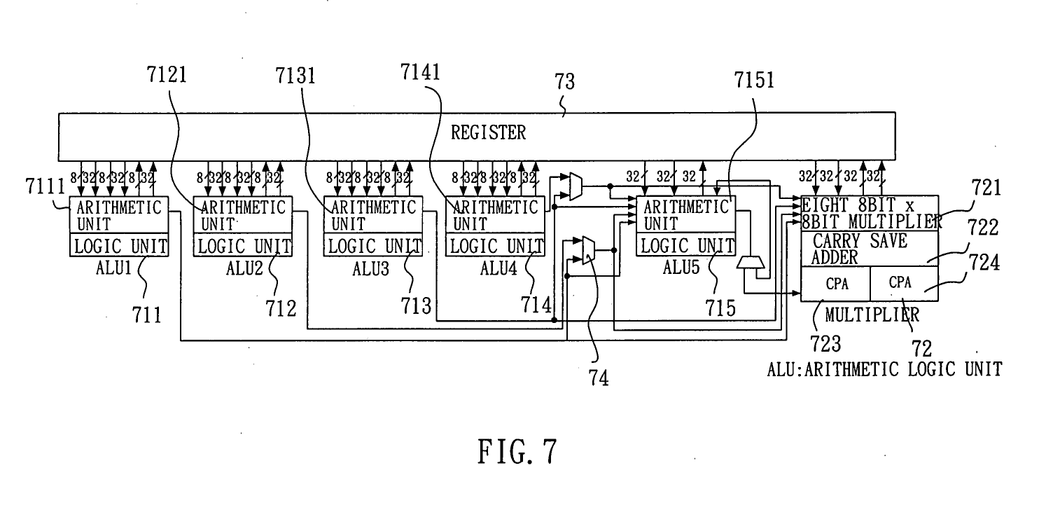

As shown in FIG. 7, the architecture of this embodiment includes a reconfigurable unit with five ALUs 711-715 and a multiplier 72. ALU1 to ALU4 can execute 40-bit arithmetic operations, 32-bit logic operation and shift operations. The arithmetic operation includes addition, subtraction and absolute value operations. The most significant 8 bits in addition and subtraction operations are treated as guard bits. ALU5 can execute a 32-bit arithmetic operation, a logic operation and a shift operation. The multiplier 72 can execute instructions for a 16×16-bit inner product, a 32×16-bit, two 16×16-bit and four 8×8-bit multiplication operations. As cited, the multiplier 72 includes eight 8×8-bit multipliers 721, one carry save adder 722 capable of adding up eight 16-bit data, and two 32-bit carry propagation adders (CPAs) 723, 724. The adders 722-724 are used to add the results generated by the eight 8×8-bit multipliers 721, to form a 32×16-bit multiplier or two 16×16-bit multipliers.

In addition to general arithmetic, logic or shift operations, the reconfigurable unit can apply the six functional units to perform following configurations: (1) combining arithmetic units 7111, 7121, 7131, 7141 respectively in ALU1, ALU2, ALU3, ALU4 and the multiplier 72, to form a functional unit capable of executing 16 8-bit subtractions and absolutions for motion estimation; (2) combining arithmetic units 7111, 7121, 7131, 7141, 7151 respectively in ALU1, ALU2, ALU3, ALU4, ALU5 and a CPA 723 in the multiplier 72, to form a functional unit capable of performing a 16×16-bit multiplication operation.

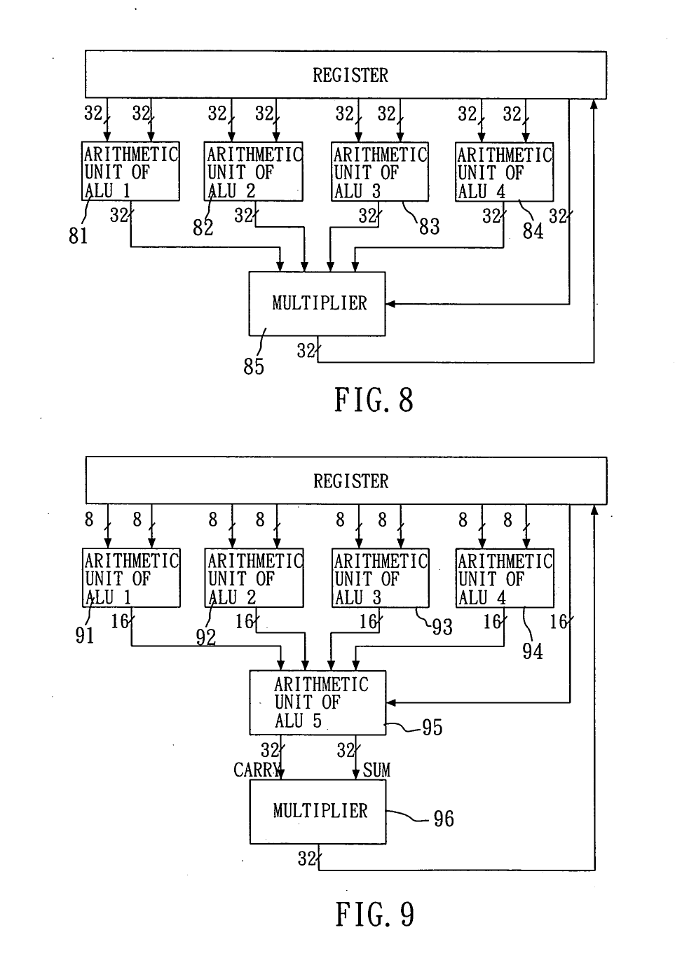

The configuration (1) generates a functional unit capable of performing 16 8-bit subtractions and absolutions for motion estimation. The motion estimation essentially computes 16 8-bit subtraction and absolution operations and thus generates 16 8-bit results. Subsequently, the 16 8-bit results are added up with one 32-bit data. FIG. 8 is a datapath of a functional unit for motion estimation generated by such a configuration. In FIG. 8, internal circuits in each arithmetic unit of ALU1, ALU2, ALU3 or ALU4 are configured as circuits capable of computing an absolute value of the result from subtracting every two of four 8-bit data. As shown in FIG. 8, four arithmetic units 81-84 produce 16 8-bit data in total. The 16 8-bit data are added up with one 32-bit data by virtue of multiple-addition feature of multiplier 85.

The performance of configuration (2) generates a functional unit capable of performing a 16×16-bit multiplication operation. The functional unit for the multiplication operation consists of four 8×8-bit multipliers, a carry save adder capable of executing four 16-bit addition operations, and a 32-bit CPA. The carry save adder can add up results generated by the four 8×8-bit multipliers to produce a carry and a sum. The CPA further adds up the carry and the sum.

FIG. 9 is a datapath of a functional unit for a 16×16-bit multiplication operation generated by such a configuration. In FIG. 9, arithmetic units 91-94 of ALU1-ALU4 are configured as four 8×8-bit multipliers. As shown in FIG. 9, with a 40-bit carry select adder used for the four arithmetic units 91-94 as corresponding internal adders, a 32-bit carry select adder in either of the units 91-94 can be configured as an 8×8-bit array multiplier. Further, as shown in FIGS. 4 and 5, because a 32-bit carry select adder and an 8×8-bit array multiplier have the highest similarity in hardware, the basic functional unit to be an adder or a multiplier can be configured under fewer switches. The arithmetic unit 95 of ALU 5 is configured as a carry save adder capable of adding four 16-bit data, such that results generated by the four 8×8-bit array multipliers in the arithmetic units 91-94 of ALU 1-ALU 4 are added up to produce a carry and a sum. One 32-bit CPA in the multiplier 96 adds up the carry and the sum. Therefore, a functional unit capable of performing a 16×16-bit multiplication operation is complete. In addition, the functional unit generated by such a configuration has independent hardware circuitry and data bus, so that at such a configuration performed, ALU 1 to ALU 5 can be used for executing logic and shift operations and the multiplier 96 can be used for executing partial multiplication at the same time.

As cited in the second embodiment, the inventive reconfigurable unit can change functional units by reconfiguration operations according to features of the algorithm required for computing, thereby increasing computing efficiency. For example, an architecture having more multipliers is configured when the algorithm needs more multiplication operations, or an architecture having more ALUs when more logic and arithmetic operations are required. In addition, multiple basic functional units are combined to form a functional unit capable of executing a specific application. Furthermore, idle circuits are reduced to the minimum because internal circuits of different basic functional units can be connected and reconfigured to form different functional units, thereby increasing a usage rate in hardware.

Although the present invention has been explained in relation to its preferred embodiment, it is to be understood that many other possible modifications and variations can be made without departing from the spirit and scope of the invention as hereinafter claimed.

1. A reconfigurable apparatus with a high usage rate in hardware, comprising:
at least one reconfigurable unit having a plurality of processing units and a plurality of switch boxes connected to the plurality of processing units, the at least one reconfigurable unit receiving at least one configuration signal and dynamically changing the plurality of processing units and the plurality of switch boxes according to the at least one configuration signal, thereby forming at least one functional unit.

2. The reconfigurable apparatus as claimed in claim 1, wherein the reconfigurable unit is homogeneous that has the same processing units, heterogeneous that has different processing units, or combined above.

3. The reconfigurable apparatus as claimed in claim 1, wherein the switch boxes comprise at least one interconnection to deliver data among the processing units.

4. The reconfigurable apparatus as claimed in claim 3, wherein the at least one switch box is a multiplexer or data bus.

5. The reconfigurable apparatus as claimed in claim 1, wherein the processing units respectively are processing elements (PEs) capable of independently executing computation.

6. The reconfigurable apparatus as claimed in claim 5, wherein the PEs are capable of executing at least 4-bit arithmetic or logic operation.

7. The reconfigurable apparatus as claimed in claim 5, wherein a plurality of functional units in a processor or system of the reconfigurable apparatus have the internal circuit blocks with the same hardware components that can be the PEs.

8. The reconfigurable apparatus as claimed in claim 5, wherein the PEs respectively have different computing functions.

9. The reconfigurable apparatus as claimed in claim 7, wherein the PEs respectively have different computing functions.

10. The reconfigurable apparatus as claimed in claim 5, wherein the PEs have the same computing function.

11. The reconfigurable apparatus as claimed in claim 7, wherein the PEs have the same computing function.

12. The reconfigurable apparatus as claimed in claim 5, wherein at least one of the PEs has different computing function from other PEs.

13. The reconfigurable apparatus as claimed in claim 7, wherein at least one of the PEs has different computing function from other PEs.

14. The reconfigurable apparatus as claimed in claim 1, wherein the processing units are basic functional units.

15. The reconfigurable apparatus as claimed in claim 14, wherein the basic functional units have internal hardware components selected from one of arithmetic logic units, multipliers, multiplication and accumulation units, registers and memory.

16. The reconfigurable apparatus as claimed in claim 14, wherein the switch boxes are used to connect the internal hardware components of the different basic functional units.

17. The reconfigurable apparatus as claimed in claim 16, wherein part of internal hardware components of one basic functional unit and part or all of internal hardware components of at least one different basic functional unit are connected to form the functional units.
